(19) United States
(12) Patent Application Publication
(10) Pub. No.: US 2004/0200958 A1
(43) Pub. Date: Oct. 14, 2004

(54) Optical semiconductor device

(75) Inventors: Akihiro Tanaka, Tokyo (JP); Hiroshi Suzunaga, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/695,791

(22) Filed: Oct. 30, 2003

(30) Foreign Application Priority Data
Apr. 9, 2003 (JP) 2003-105514

(51) Int. Cl. G01D 5/34

(52) U.S. Cl. 250/231.13

(57) ABSTRACT

An optical encoder comprises a plurality of first photodiodes, a second photodiode and a circuit. The plurality of first photodiodes are arranged in a first direction, each of the first photodiodes has a light detecting part extending along a direction substantially perpendicular to the first direction. The second photodiode is arranged near tips of the first photodiodes, and has a light detecting part extending along the first direction. The circuit performs a calculation based on outputs of the first and second photodiodes.

### CROSS-REFERENCE TO RELATED APPLICATIONS

This application is based upon and claims the benefit of priority from the prior Japanese Patent Application No. 2003-105514, filed on Apr. 9, 2003; the entire contents of which are incorporated herein by reference.

### BACKGROUND OF THE INVENTION

The present invention relates to an optical encoder, and more particularly, it relates to an optical encoder using photodiodes.

An optical encoder is used as a means for detecting a position, for example, is used for detecting a position of a print head in a printer and for controlling the amount of paper feed in a copy machine, etc.

FIG. 11 is a schematic diagram which illustrates the principal part section structure of the optical encoder.

That is, in the optical encoder illustrated in this figure, light emitting elements 31 and photo-detecting devices 32 are provided in an opposed fashion. The light emitting element 31 has a structure where a LED (light emitting diode) 70 is mounted at the tip of a lead frame 40 and its circumference is appropriately molded with resin. On the other hand, the photo-detecting device 32 has a structure where a photo-detecting IC 80 is mounted at the tip of a lead frame 50 and its circumference is appropriately molded with resin.

A scale 33 is inserted between the light emitting element 31 and the photo-detecting device 32, and a relative displacement between the scale 33 and the encoder is detected.

FIG. 12 is a schematic diagram which illustrates the planar pattern of the photodiodes formed in the photo-detecting IC 80. A plurality of photodiodes which consist of planar p-n junctions and their drive circuits are provided in the photo-detecting IC 80, as will be explained later. The optical detector circuit using such photodiodes is disclosed in Japanese Patent Disclosure No. 2002-340669.

As illustrated in FIG. 12, these photodiodes (1c, 1d, . . . ) are formed substantially in a shape of a rectangle, and are arranged in a form of an array in the direction of Y shown the figure. And these photodiodes are connected to the wirings (30a-30d) of four phases in turn through the contacts 20.

That is, adjacent four photodiodes (1a-1d, 2a-2d, . . . ) are connected to form one set.

FIG. 13 is a schematic diagram showing an arrangement of the scale 33 and the photodiodes.

That is, the patterns 34 which allow the light pass therethrough, and the patterns 35 which shields the light, are provided by turns in the scale 33. The pitch of these patterns 34 and 35 matches substantially to the pitch of the photodiodes (1c, 1d, . . . ). For example, in the example expressed in this figure, the light and dark patterns 34 and 35 in the scale 33 match with one set of the photodiodes (1a-1d, 2a-2d).

The light coming from the light emitting element 31 penetrates the scale 33, and goes into the photo-detecting device 32 with the light and dark patterns which are made by the light and dark patterns 34 and 35 in the scale.

A difference of the photoelectric current which flows to the photodiodes arises by these light and dark patterns. This difference of the photoelectric current is detected in a circuit, and outputted.

In the example expressed in FIG. 13, if the relative displacement between the scale 33 and the photo-detecting device 31 changes, the photoelectric current of waveform as illustrated in FIG. 14 will be acquired in each of the four-phase wirings (30a-30d) connected to the photodiodes. By reading out the change of the waveform obtained from each of the wirings (30a-30d) of four phases, the direction and the quantity of the relative displacement between the scale 33 and the encoder can be determined.

However, a dynamic range has become narrower since DC component of the waveform of the photoelectric current has become higher in the conventional optical encoder. That is, as shown in FIG. 14, the waveform of the photoelectric current acquired from the photodiodes is a combination of DC current component (OFS) and AC current component (AC1 or AC2). The problem is that the photoelectric current has the DC current component (OFS) The light and dark pattern is given to the light which incidences to the photodiodes by the scale 33.

However, the light also goes into the photodiodes under the dark pattern 35 which should be shielded from the light. Such a undesirable irradiation is caused by the influence of refraction and diffraction of the light which penetrated the light pattern 34 of the scale 33, and/or by a circumference light. Therefore, such a DC component (OFS) is produced.

Moreover, the cross talk by the light or the photo-generated carriers between adjacent photodiodes also produces the DC component (OFS).

Since AC current component is relatively weakened by the generation of the DC component, the output waveform is distorted in a current-voltage conversion circuit. Therefore, the output characteristic (a duty ratio and phase difference) of the circuit becomes degraded. In order to extend a dynamic range against this, power supply voltage must be made higher so that AC component may not be crushed, even if the input of light becomes strong. It becomes disadvantageous with regard to the requirement of reduction in the power supply voltage of the circuit.

Furthermore, such a DC component (OFS) tends to become larger with the miniaturization of the encoder. This is because the interval between the light emitting element 31 and the photo-detecting device 32 is also reduced with the miniaturization of the encoder, and the light which comes to the photo-detecting device 32 from the light emitting element 31 becomes less parallel. For this reason, an improvement is needed also when advancing the miniaturization of the optical encoder.

### SUMMARY OF THE INVENTION

According to an embodiment of the invention, there is provided an optical encoder comprising: a first optical detector whose output changes with a movement along a first direction of a series of light and dark patterns of a pitch smaller than a predetermined value; a second optical detector whose output is constant with the movement along the first direction of the series of light and dark patterns having the pitch smaller than the predetermined value; and a circuit which performs a calculation based on the outputs of the first and second optical detectors.

According to other embodiment of the invention, there is provided an optical encoder comprising: a plurality of first photodiodes arranged in a first direction, each of the first photodiodes has a light detecting part having a longer axis along a second direction substantially perpendicular to the first direction; a second photodiode arranged near lengthwise tips of the first photodiodes, and having a light detecting part having a longer axis along the first direction; and a circuit which performs a calculation based on outputs of the first and second photodiodes.

According to other embodiment of the invention, there is provided an optical encoder comprising: a plurality of first photodiodes arranged in a first direction; a plurality of second photodiodes commonly connected to a same wiring, each of the second diodes being arranged between the first photodiodes; and a circuit which performs a calculation based on outputs of the first and second photodiodes.

### BRIEF DESCRIPTION OF THE DRAWINGS

The present invention will be understood more fully from the detailed description given herebelow and from the accompanying drawings of the embodiments of the invention. However, the drawings are not intended to imply limitation of the invention to a specific embodiment, but are for explanation and understanding only.

In the drawings:

FIG. 1 is a plan view which illustrates the composition of the photodiodes of the optical encoder according to the embodiment of the present invention;

FIG. 2 is a schematic diagram showing an example of the cross-sectional structure of the photodiodes of the embodiment;

FIG. 3 is a schematic diagram showing another example of the cross-sectional structure of the photodiodes of the embodiment;

FIG. 4 is a schematic diagram showing a circuit which can be used in the optical encoder of the embodiment;

FIGS. 5A and 5B are schematic diagrams for explaining the cancellation effect of DC component obtained in the present invention;

FIG. 6 is a schematic diagram showing another example of the circuit which can be used in the present invention.

FIG. 7 is a plan view showing the second example of the photodiodes which can be used in the present invention.

FIG. 8 is a schematic diagram showing an example of the cross-sectional structure of the photodiodes of the embodiment;

FIG. 9 is a schematic diagram showing another example of the cross-sectional structure of the photodiodes of the embodiment;

FIG. 10 is a schematic diagram showing the third example of the photodiodes which can be used in the present invention;

FIG. 11 is a schematic diagram which illustrates the principal part section structure of the optical encoder.

FIG. 12 is a schematic diagram which illustrates the plan pattern of the photodiodes formed in the photo-detecting IC 80;

FIG. 13 is a schematic diagram showing an arrangement of the scale 33 and the photodiodes; and

FIG. 14 is a graphical representation showing the waveform of photoelectric current.

### DETAILED DESCRIPTION

Referring to drawings, some embodiments of the present invention will now be described in detail.

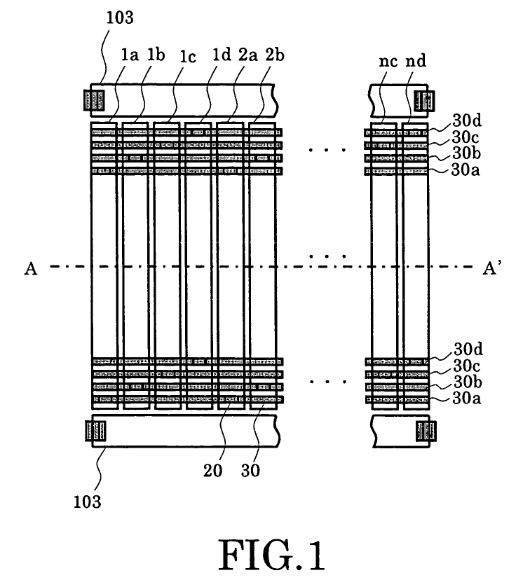

FIG. 1 is a plane view which illustrates the structure of the photodiodes of the optical encoder according to the embodiment of the present invention. Also in this embodiment, the photodiodes for signal output with a shape of rectangle (1a, 1b, . . . , nd) are provided in parallel. Each of these photodiodes for signal output is connected to either of the wirings 30a-30d of four phases. That is, the photodiode groups (1a-na, 1b-nd, 1c-nc, 1d-nd) of four phases are provided. The photodiodes of each group are commonly connected by the either of the wirings 30a-30d of four phases.

The adjacent photodiodes (for example, 1a-1d) are arranged so that they may belong to the different photodiode groups, respectively. And the photodiodes 103 for DC cancellation are provided at the top and the bottom of the photodiodes for signal output. The photodiodes 103 for DC cancellation are not divided with a predetermined pitch, but are formed in the shape of a stripe which are extending continuously along the direction of the array of the photodiodes for signal output.

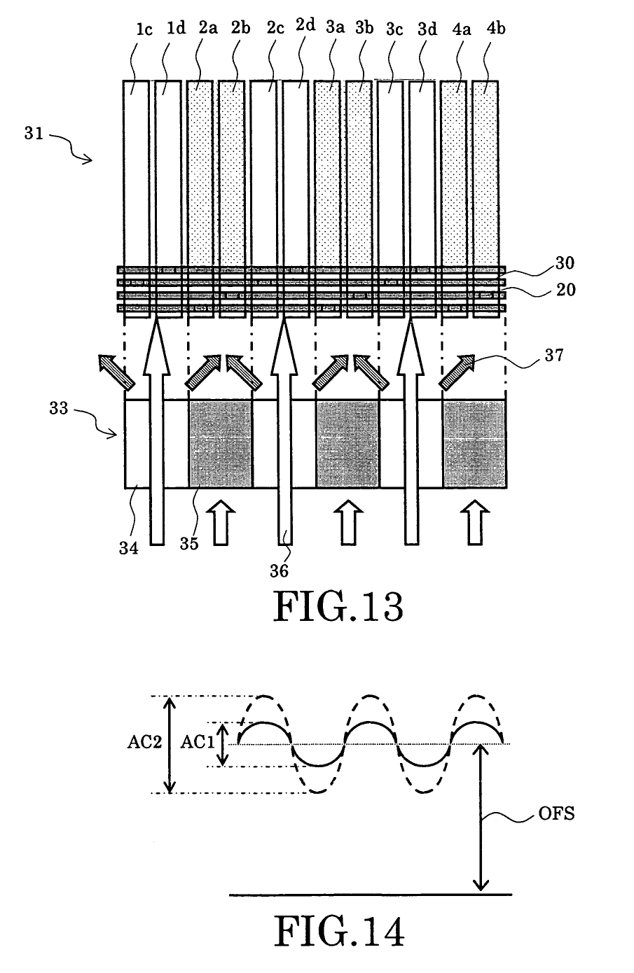

In photodiodes 1a-nd for signal output, the photoelectric currents flow corresponding to the change of the light and dark patterns of the light by the relative displacement with the scale which is not shown, as mentioned above with reference to FIG. 13. On the other hand, a constant light is always irradiated to the photodiodes 103 for DC cancellation, without depending on the displacement of the scale. That is, even if the position of the scale changes, the area where the light is irradiated and the area where the light is not irradiated are constant, since the width of the longitudinal direction of these photodiodes 103 for DC cancellation is larger than the pitch of the light-and-dark patterns of the scale which is not shown.

Thus, it becomes possible to acquire the constant photoelectric current. Therefore, the DC components in the photoelectric currents of photodiodes 1a-nd for signals can be cancelled by using the photoelectric current from the photodiodes 103 for DC cancellation.

The structure of the circuit will be explained in full detail below.

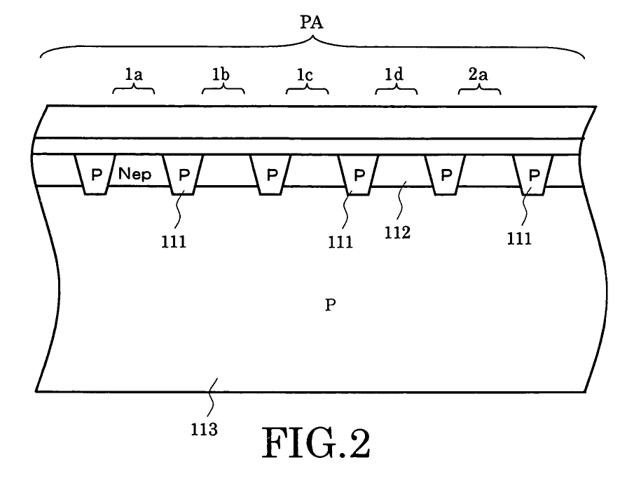

FIG. 2 is a schematic diagram showing an example of the cross-sectional structure of the photodiodes of this embodiment. That is, this figure is an A-A line sectional view of FIG. 1.

In this example, an n type epitaxial layer 112 is provided on a p type silicon substrate 113 and thus, p-n junction photodiodes (1a, 1b, . . . ) are formed. And these photodiodes are mutually separated by the p type separation regions 111.

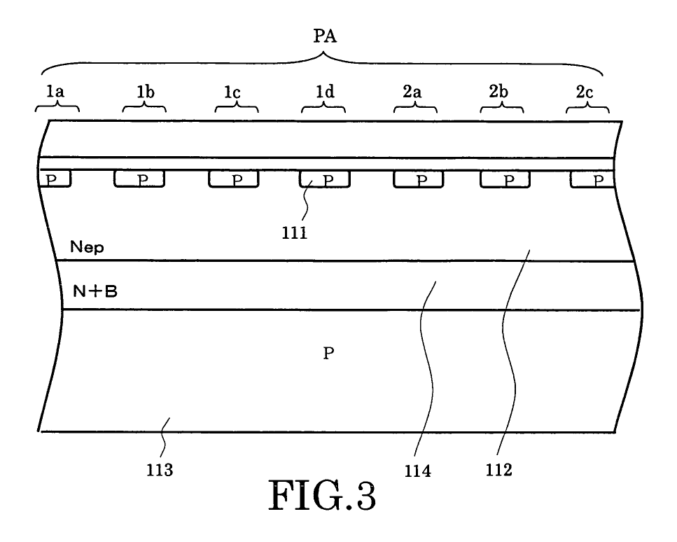

FIG. 3 is a schematic diagram showing another example of the cross-sectional structure of the photodiodes of this embodiment. That is, this figure is an A-A line sectional view of FIG. 1.

In this structure, an n+ type embedding layer 114 is provided on the p type silicon substrate 113 and the n type epitaxial layer 112 is formed on it. And the p type diffusion layers 111 are formed on the surface in a planar fashion.

The photodiodes (1a, 1b, . . . ) are obtained by the p-n junctions which are formed by these diffusion layers 111.

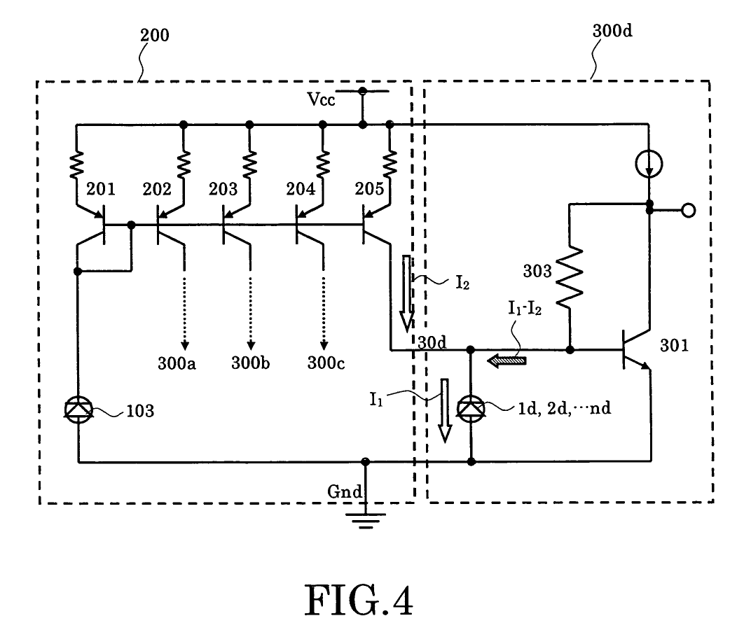

FIG. 4 is a schematic diagram showing a circuit which can be used in the optical encoder of this embodiment.

That is, this figure expresses the circuit which can be provided in the semiconductor which has a cross-sectional structure shown in FIG. 2. This circuit can be provided around the photodiodes obtained by forming the n type epitaxial layer 112 on the p type silicon substrate.

This circuit has the current-voltage conversion parts 300a-300d, and a DC cancellation part 200.

Each of the photodiode groups (1a-na, 1b-nb, 1c-nc, 1d-nd) for signal output is connected to each of the current-voltage conversion parts 300a-300d. FIG. 4 expresses the current-voltage conversion part 300d of the whole circuit.

That is, in the current-voltage conversion part 300d, the photoelectric current which flows in the photodiode group (1d-nd) is converted into a voltage by the conversion transistor 301 and the resistance 303 and outputted. Other current-voltage conversion parts 300a-300c which are not shown have the same structure.

On the other hand, the photodiodes 103 for DC cancellation are connected to DC cancellation part 200. The anode of the photodiode 103 for DC cancellation is grounded (Gnd). On the other hand, the cathode of the photodiode 103 for DC cancellation is connected to the base and the collector of the reference PNP transistor 201 of the current mirror circuit. And the photodiode 103 for DC cancellation is connected so that the current may be turned to the PNP transistors (202-205) from the reference PNP transistor 201. The collector of the PNP transistor 205 is connected to the current-voltage conversion part 300d, and the currents flows to the cathode of the photodiode group (1d-nd) through the wiring 30d. Although illustration is omitted, the collectors of the PNP transistors 202, 203, and 204 are connected to the cathodes of the photodiode groups 1a-na, 1b-nb and 1c-nc in the current-voltage conversion parts 300a, 300b, and 300c, respectively.

By the configuration of this circuit, the input current of the current-voltage conversion circuit 300d is set to (I1-I2). That is, the amount of the input current is cancelled (subtracted) by the amount of current I2. The current I2 is formed of the photoelectric current which flows the photodiode 103 for DC cancellation. And the current I2 can compensate the DC component of the signals obtained from the photodiode groups for signal output.

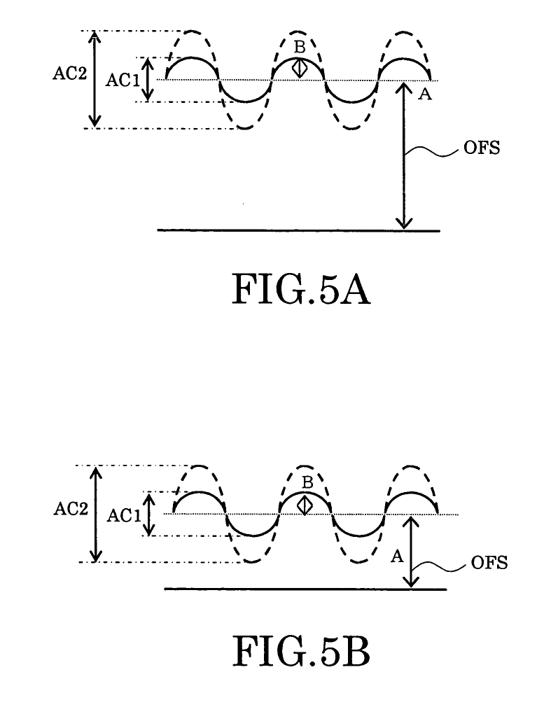

FIGS. 5A and 5B are schematic diagrams for explaining the cancellation effect of DC component according to the present invention. That is, FIG. 5A is a graphical representation showing the light signal acquired from the conventional optical encoder which was illustrated in FIG. 14, and FIG. 5B is a graphical representation showing the light signal acquired from the optical encoder of this embodiment.

The light signal acquired from the encoder has the DC component and AC component, as mentioned above. AC component may have comparatively large amplitude expressed with the dotted line, or small amplitude expressed with the solid line in this figure, in corresponding to the arrangement relation between the light emitting element and the photo-detecting device. As shown in FIG. 5A, when the DC cancellation is not carried out, the ratio of A and B, A:B is about 5:1, where A is the level of the DC component and B is the smaller amplitude of AC component (solid line).

In contrast to this, according to the embodiment, as shown in FIG. 5B, the level A of DC component can be lowered so that A:B becomes 2:1 or even better. That is, according to the embodiment, the DC offset level A (OFS) can be effectively reduced.

The current I2 for canceling is set to be lower than the photoelectric current I1. The amount of each photoelectric current can be estimated from the area of the photodiodes for signal output and the photodiodes for DC cancellation.

And thus, the current ratio of the current mirror circuit can be freely set within the range of 12<11. Since the ratio of current mirror can be set freely, the current I2 needed for cancellation of DC current component can be set to the optimum amount of DC cancellations (current value).

Consequently, it becomes also possible to lower the level of DC component in the output signal acquired from the current-voltage conversion part 300 to almost zero. If the dynamic range of the output voltage of the current-voltage conversion circuit 300 is wide enough, it is also possible to set up the condition other than I1<I2.

According to the embodiment, the following effects are acquired by reducing the DC component in the photoelectric current.

First, the dynamic range of the signal can be extended. That is, even if the optical intensity of the light emitting element fluctuates, the change of the photoelectric current can be suppressed by canceling (subtracting) DC current component of the photoelectric current of the photodiode for signal output in the circuit. As the result, the input dynamic range of the circuit can be extended.

Second, the power supply voltage of the circuit can be lowered. That is, it has ever been necessary to raise the power supply voltage in order to extend the dynamic range of the current-voltage conversion circuit. In contrast to this, according to the embodiment, since the change of the photoelectric current produced by the fluctuation of the optical intensity of the light emitting element can be suppressed, it becomes possible to extend the dynamic range. Consequently, it becomes unnecessary to raise the power supply voltage, and it becomes possible to reduce the power supply voltage of the circuit.

Moreover, the accuracy of the output characteristic (duty and phase difference) of the encoder can be improved. That is, since the photoelectric current of AC component with large amplitude can be taken out by lowering DC component, it becomes possible to obtain an output characteristic (a duty ratio and phase difference) which is important as the encoder with more sufficient accuracy.

Furthermore, the encoder can be easily miniaturized. That is, in the optical encoder, since the interval between the light emitting element and the photo-detecting device must be reduced with the miniaturization, the parallelity of the light incident to the photo-detecting device is degraded. Thus, the light-and-dark patterns of the scale are not faithfully inputted to the photo-detecting device, and the DC component tends to increase by the diffraction of the light.

In contrast to this, according to the embodiment, since the DC component can be reduced certainly and easily, it becomes possible to miniaturize the optical encoder while securing a high resolution.

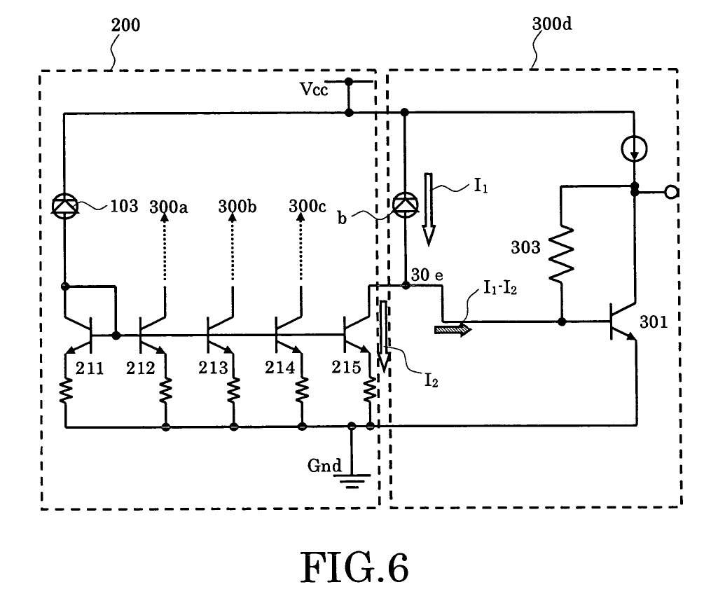

FIG. 6 is a schematic diagram showing another example of the circuit which can be used in the present invention. That is, this figure expresses the circuit which can be provided in the circumference of photodiodes which are formed by forming the p type diffusion layers on the surface of the n type epitaxial layer, as shown in FIG. 3.

The circuit of this example also has the current-voltage conversion parts 300a-300d, and DC cancellation part 200. And the cathode of the photodiode 103 for DC cancellation is connected to Vcc, and the anode is connected to the base and the collector of the reference NPN transistor 211 of the current mirror circuit. The current is turned to the NPN transistors (212-215) from the reference NPN transistor 211. The collector of the NPN transistor 215 is connected to the anode of the photodiode group (1d-nd) for signal output.

By this circuit configuration, the input current of the current-voltage conversion circuit becomes (I1-I2), and the current of the same amount of the current I2 san be canceled.

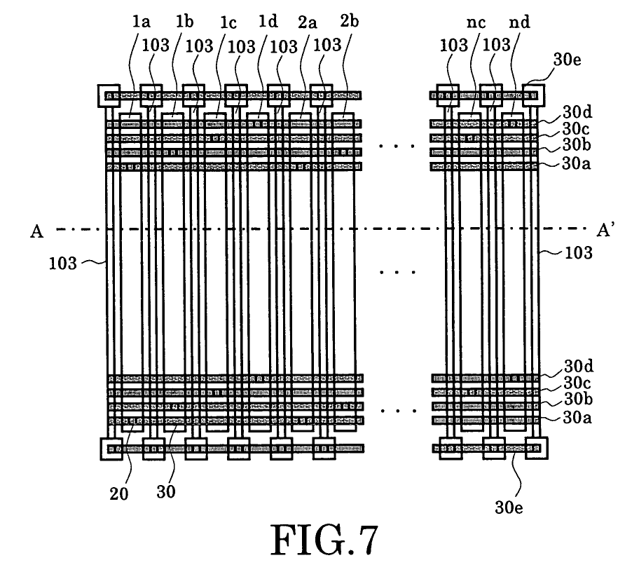

FIG. 7 is a plane view showing the second example of the photodiodes which can be used in the present invention. The same symbols are given to the same elements as what were mentioned above with reference to FIG. 1 through FIG. 6 about this figure, and detailed explanation will be omitted.

In this embodiment, the photodiodes 103 for DC cancellation are provided between the photodiodes (1a, 1b, . . . , nd) for signal output. These photodiodes 103 for DC cancellation are connected in common by the wiring 30e.

When the scale 33 shown in FIG. 13 is used, two photodiodes (for example, 1a and 1b) of 1 set (for example, 1a-1d), i.e., four adjacent photodiodes for signal output are under the light pattern 34, and the two remaining photodiodes (for example, 1c and 1d) are under the dark pattern 35, for example. Similarly, the light is irradiated to two of four photodiodes 103 for DC cancellation, and the light is not irradiated to the remaining two of the adjacent four photodiodes 103.

However, since the wiring 30e connects these photodiodes 103 for DC cancellation, the amount of the light irradiated to all the photodiodes 103 for DC cancellation is always constant without depending on the position of the scale. That is, the constant photoelectric current can always be acquired from the photodiodes 103 for DC cancellation. The DC component in the photoelectric current of photodiodes 1a-nd for signal output can be cancelled by using this photoelectric current of the photodiodes 103. The circuit mentioned above with reference to FIGS. 5A through 6 can be used for this cancellation.

Furthermore, since the photodiodes 103 for DC cancellation are inserted between the adjacent photodiodes for signal output, the “cross talk” between the photodiodes for signal output can be reduced in this embodiment. For example, in FIG. 7, the cross talk (mutual interference of photoelectric current) between these photodiodes 1a and 1b can be reduced by providing the photodiode 103 for DC cancellation between these photodiodes 1a and 1b for signal output. That is, the excessive photoelectric current produced by the photo carrier generated in a semiconductor layer when the light irradiates the photodiodes for signals, can be absorbed by the photodiodes 103 for DC cancellation.

Therefore, the photoelectric current can be taken out efficiently and the influence of the mutual interference between the photodiodes for signal output can be reduced. Consequently, spatial detection resolution can be improved.

That is, since the photoelectric current with high-precision can be taken out, it becomes possible to obtain an output characteristic (a duty ratio and phase difference) which is important as the encoder with more sufficient accuracy.

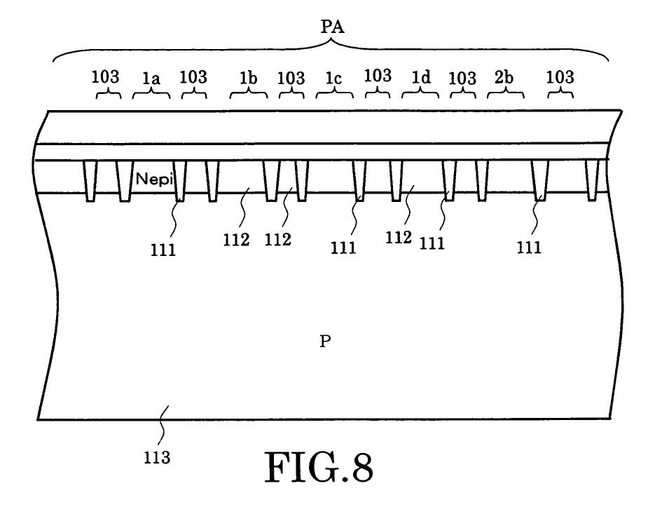

FIG. 8 is a schematic diagram showing an example of the cross-sectional structure of the photodiodes of this embodiment. That is, this figure expresses the A-A line section structure of FIG. 7.

This example has the same stacking structure as what was expressed with reference to FIG. 2. That is, the n type epitaxial layer 112 is provided on the p type silicon substrate 113, and thus, the p-n junction photodiodes (1a, 1b, . . . ) are formed. And these photodiodes are mutually separated by the p type separation regions 111.

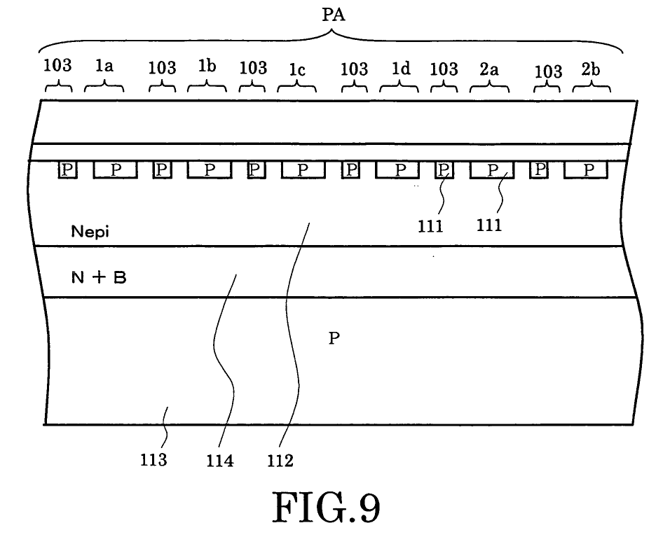

FIG. 9 is a schematic diagram showing the cross-sectional structure of another example of the photodiode of this embodiment. That is, this figure expresses the A-A line sectional structure of FIG. 4.

This example has the same stacking structure as what was expressed with reference to FIG. 3. That is, the n+ type embedding layer 114 is provided on the p type silicon substrate 113, and the n type epitaxial layer 112 is formed on it. And the p type diffusion layers 111 are formed on the surface in a planar fashion. The photodiodes (1a, 1b, . . . ) are formed by the p-n junctions which are formed by the diffusion layer 111.

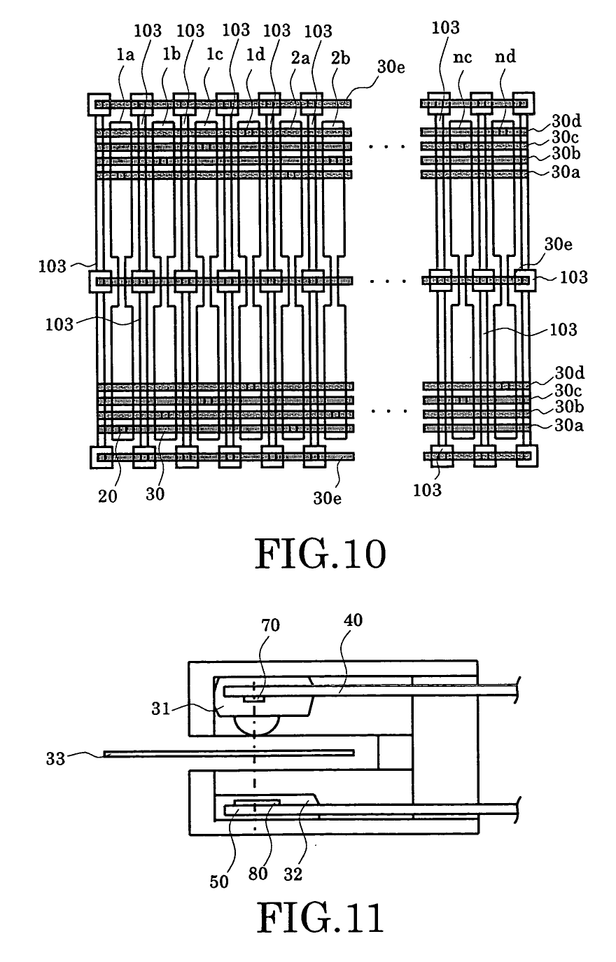

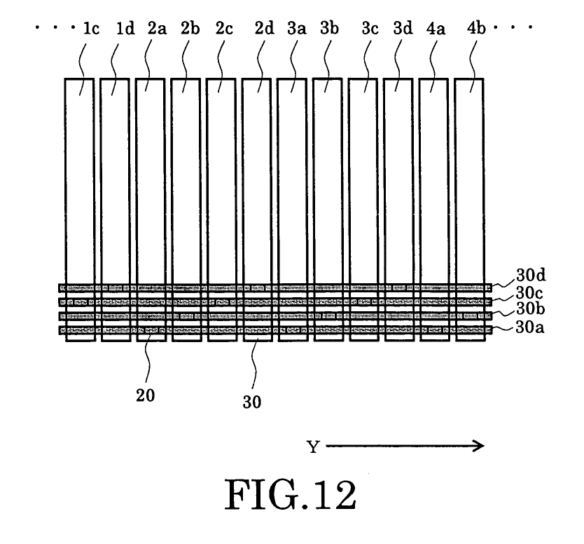

FIG. 10 is a schematic diagram showing the third example of the photodiodes which can be used in the present invention. The same symbols are given to the same elements as what were mentioned above with reference to FIG. 1 through FIG. 9 about this figure, and detailed explanation will be omitted.

Also in this example, the photodiodes 103 for DC cancellation are provided between the photodiodes for signals (1a, 1b, . . . , nd). However, the photodiodes 103 for DC cancellation are connected in common by the wiring 30e not only at the top and the bottom but also at the center.

Since the photodiodes 103 for DC cancellation in this example are formed in the up-and-down direction in this figure with a shape of a long and slender stripe, the electric resistance of the up-and-down direction tends to become high.

According to the example, the output impedance for the photoelectric current from the photodiodes 103 for DC cancellation can be lowered by connecting the wiring 30e at the center of the photodiodes, as shown in FIG. 10.

Moreover, also in this example, the cross talk between these photodiodes for signal output can be suppressed by providing the photodiodes 103 for DC cancellation between these photodiodes for signal output.

Heretofore, the embodiments of the present invention have been explained, referring to the examples. However, the present invention is not limited to these specific examples.

For example, the photodiodes for DC cancellation shown in FIG. 1 and the photodiodes for DC cancellation shown in FIG. 7 or FIG. 10 may be combined. Then, while it becomes possible to increase the photo-detecting area of the photodiodes for DC cancellation and the amount of the photoelectric current for cancellation, it also becomes possible to prevent the cross talk between the photodiodes for signal output.

Moreover, about the materials, the conducted type, carrier concentration, impurities, thickness, arrangement, pattern form, etc. of the light emitting elements, the photo-detecting devices, the semiconductor substrates, the semiconductor layers, the electrodes and the circuits, may be appropriately selected by those skilled in the art with the known techniques to carry out the invention as taught in the specification and obtain equivalent effects.

Any embodiments about the optical encoder which are selected by those skilled in the art within the known techniques may be included in the present invention, as long as the feature of the present invention is included therein.

While the present invention has been disclosed in terms of the embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. An optical encoder comprising:
a first optical detector whose output changes with a movement along a first direction of a series of light and dark patterns of a pitch smaller than a predetermined value;
a second optical detector whose output is constant with the movement along the first direction of the series of light and dark patterns having the pitch smaller than the predetermined value; and
a circuit which performs a calculation based on the outputs of the first and second optical detectors.

2. The optical encoder according to claim 1, wherein:
the first optical detector has
a plurality of first photodiodes arranged along the first direction; and
a plurality of wirings,
the plurality of first photodiodes consist of a plurality of diode groups, each of the photodiodes belonging to the same diode group being commonly connected to one of the wirings, and adjacent photodiodes belonging to different diode groups.

3. The optical encoder according to claim 1, wherein the second optical detector has a second photodiode whose light detecting part is larger than the pitch along the first direction.

4. The optical encoder according to claim 2, wherein the second optical detector has a second photodiode whose light detecting part is larger than the pitch along the first direction.

5. The optical encoder according to claim 1, wherein the second optical detector has:
a plurality of second photodiodes arranged along the first direction; and
a wiring commonly connecting the plurality of second photodiodes.

6. The optical encoder according to claim 2, wherein the second optical detector has:
a plurality of second photodiodes arranged along the first direction; and
a wiring commonly connecting the plurality of second photodiodes.

7. The optical encoder according to claim 5, wherein each of the second photodiodes is provided between the first photodiodes.

8. The optical encoder according to claim 7, wherein each of the first photodiodes has a light detecting part substantially having a shape of rectangle extending along a second direction perpendicular to the first direction, and
each of the second photodiodes has a light detecting part substantially having a shape of rectangle extending along the second direction perpendicular to the first direction.

9. The optical encoder according to claim 5, wherein the wiring has a line connected to a center part of each of the second photodiode.

10. The optical encoder according to claim 2, wherein the circuit multiplies the output of the second optical detector by a constant factor, and subtracts a result of the multiplication from the output of the first optical detector.

11. The optical encoder according to claim 10, wherein the result of the multiplication is smaller than the output of the first optical detector.

12. An optical encoder comprising:
a plurality of first photodiodes arranged in a first direction, each of the first photodiodes having a light detecting part having a longer axis along a second direction substantially perpendicular to the first direction;
a second photodiode arranged near lengthwise tips of the first photodiodes, and having a light detecting part having a longer axis along the first direction; and
a circuit which performs a calculation based on outputs of the first and second photodiodes.

13. The optical encoder according to claim 12, wherein every fourth photodiode of the first photodiodes is connected to a same wiring.

14. The optical encoder according to claim 12, wherein the circuit multiplies an output of the second photodiode by a constant factor, and subtracts a result of the multiplication from an output of the first photodiodes.

15. The optical encoder according to claim 14, wherein the result of the multiplication is smaller than the output of the first photodiodes.

16. An optical encoder comprising:
a plurality of first photodiodes arranged in a first direction;
a plurality of second photodiodes commonly connected to a same wiring, each of the second photodiodes being arranged between the first photodiodes; and
a circuit which performs a calculation based on outputs of the first and second photodiodes.

17. The optical encoder according to claim 16, wherein each of the second photodiodes is provided between the first photodiodes.

18. The optical encoder according to claim 16, wherein every fourth photodiode of the plurality of the first photodiodes is connected to a same wiring.

19. The optical encoder according to claim 16, wherein the circuit multiplies an output of the second photodiode by a constant factor, and subtracts a result of the multiplication from an output of the first photodiodes.

20. The optical encoder according to claim 19, wherein the result of the multiplication is smaller than the output of the first photodiodes.
